(19) United States
(12) Patent Application Publication
(10) Pub. No.: US 2005/0250639 A1
(43) Pub. Date: Nov. 10, 2005

(54) Lithium-aluminosilicate flat float glass

(76) Inventors: Friedrich Siebers, Nierstein (DE); Gerhard Lautenschlager, Jena (DE); Klaus Schneider, Apolda (DE); Andreas Sprenger, Rothenstein (DE)

Correspondence Address: FULBRIGHT & JAWORSKI, LLP, 666 FIFTH AVE, NEW YORK, NY, 10103-3198, US

(21) Appl. No.: 11/105,196

(22) Filed: Apr. 12, 2005

(30) Foreign Application Priority Data
May 7, 2004 (DE) 10 2004 022 629.6

(51) Int. Cl. C03C 3/083; C03C 3/091

(52) U.S. Cl. 501/68; 501/66

(57) ABSTRACT

Lithium-aluminosilicate flat float glass with a high thermal stability, which can be chemically and thermally tempered and is refined without using the standard refining agents arsenic oxide and/or antimony oxide, having a composition which, in % by weight based on the total composition, contains the following main constituents:

| | |
|---|---|
| Li₂O | 2.5-6.0 |
| Σ Na₂O + K₂O | <4 |
| B₂O₃ | 0-<4 |
| Al₂O₃ | 15-30 |
| SiO₂ | 55-75 |
| Σ TiO₂ + ZrO₂ | <2 in order to avoid the |
| | crystallization of undesirable |
| | beta-quartz and/or keatite |
| | solid solutions |

and the use of this glass.

The invention relates to a lithium-aluminosilicate flat float glass with a high thermal stability which can be chemically and thermally tempered.

Many special glass applications require flat glass, for example in the form of glass panes as viewing windows, for display purposes and as hard disk memory substrates. Flat glass of this type is produced from the glass melt using the known processes, such as rolling, drawing, casting or the float process. The float process is in widespread use on account of being economical and producing a high surface quality of the flat glasses.

The production of soda-lime glasses and of special glasses, such as for example borosilicate glasses or aluminosilicate glasses, by the float process is known.

To increase the strength of glasses, they are chemically or thermally tempered in this technology.

(Thermally tempered) fireproof glasses which satisfy the conditions of fire resistance classes G (DIN 4102 Part 13, ISO 834) have already been developed. The fireproof glazing, including frame and holding means, in accordance with the fire resistance classes, have to withstand thermal loading under the unit temperature-time curve in accordance with DIN 4102 (or ISO 834) for between 30 and 180 minutes and thereby prevent fire and smoke from passing through.

Similar regulations apply to classes F 30, F 60, F 90 and F 120, with the glasses additionally not being permitted to be heated by on average more than 140° C. above the starting temperature on the side remote from the fire.

Furthermore, additional demands are often placed on glazing panels used in buildings. For example, glazing used in doors, in addition to being fireproof, also has to ensure that the users are safe. For this purpose, the glazing has to satisfy not only the requirements of the fireproofing standards but also those of the relevant safety glass standards (e.g. single-pane safety glass DIN 1249, Part 12 or DIN EN 12150).

For example, in accordance with DIN 1249 it is possible to produce safety glasses which break into a large number of fragments without any sharp edges in the event of extremely strong loads.

During thermal tempering, suitable glasses, for example in the form of panes that have been cut to size, are heated to temperatures above the transformation temperature and then cooled very quickly by a cold air stream. This heating and rapid cooling process produces compressive stresses in the surface of the glass and tensile stresses in the interior. This results in a considerable increase in the tensile bending strength of the glass, a reduced susceptibility to temperature fluctuations and high resilience.

For example, there are known fireproof glazing panels in which tempered soda-lime glasses of suitable thickness are used. These are known, for example, in thicknesses of 6-15 mm for fire resistance times of 30 or 60 minutes. However, these tempered soda-lime glasses have the drawback that during the thermal loading which occurs in the event of a fire load in accordance with the unit temperature-time curve they exceed their softening point at a relatively early stage (before minute 30), and the previously strong, elastic glasses then change into a plastic state with a low viscosity.

However, achieving high fire resistance times is primarily dependent on the softening of the glasses (softening point logη=7.6). Other influencing factors are the size of pane, the thickness of pane and the width of the edge cover, as well as the holding forces of the pane and the condition of the frames (material).

For example, the wider the edge covering of the pane, the longer the glasses are prevented from slipping out of the edge region when the glasses, during the fire load, have reached their softening point.

At the same time, however, the width of the covered edge region, in connection with the linear coefficient of thermal expansion of the glass, is a determining factor for the level of stresses formed between the hot (unsupported) centre of the pane and the cold (covered) edge of the pane under fire loads.

If the stresses which are produced in the event of a fire exceed the strength of the glass, the glass pane will inevitably fracture, leading to complete loss of the protective action of the fireproof glazing.

Therefore, it is not readily possible for the edge covering of the panes to be selected to be as large as desired in order to achieve the highest possible fire resistance time.

Therefore, the high coefficient of thermal expansion and the low softening point of soda-lime glass is disadvantageous for fireproofing applications.

During chemical tempering, the compressive stress in the surface of the glass is achieved by ion exchange.

In this process, ions with a larger radius, which penetrate into the glass from the outside, replace smaller ions. The larger amount of space taken up by the penetrating ions produces a high compressive stress in the surface, allowing the strength to be increased 5 to 8 times.

The ion exchange is generally carried out using alkali metal atoms, either in molten salts or with the aid of applied solutions or pastes. Treatment with potassium atoms which are exchanged for sodium atoms in the glass is customary. It is important for the treatment to take place below the transformation temperature of the glass, since otherwise the compressive stress is thermally reduced by stress relief in the glass. A temperature of approximately 100° C. below the transformation temperature has proven favourable for the ion exchange. At lower temperatures, longer times are required for the treatment.

In the case of both thermal and chemical tempering, the desired effect of increasing strength is produced by means of a compressive stress introduced into the surface of the glass.

The two processes differ in economic and technical respects and have therefore opened up different application areas. Thermal tempering is highly economical on account of the short process times. Chemical tempering achieves very high strengths.

Soda-lime glasses which have been produced by the float process and thermally tempered are therefore in widespread use, for example in glazing for buildings or as curved windscreens for the glazing of automobiles. During production, these glasses are usually subjected to sulphate refining in order to achieve the required numbers of bubbles.

On account of their composition, borosilicate glasses which have been produced by the float process and thermally tempered have a higher thermal stability and higher chemical resistance than soda-lime glasses. They require higher melting temperatures and are refined using NaCl. Consequently, borosilicate float glasses are used where it is important to achieve a higher chemical resistance and a higher thermal stability.

On account of their low Al₂O₃ and generally also low Li₂O contents, they are thus suitable for chemical tempering and constitute a different type of glass.

It is known that lithium-aluminosilicate glasses can be chemically tempered very successfully. On account of the good diffusion of the lithium atom, thicker compressive-stress layers can be achieved within acceptable exchange times in the case of exchange for sodium atoms than when exchanging sodium atoms for potassium atoms in an Li₂O-free glass with Na₂O as active component.

For example, U.S. Pat. No. 4,156,755 describes a chemically temperable glass having a composition, in % by weight, of 59-63 SiO₂, 10-13 Na₂O, 4-5.5 Li₂O, 15-23 Al₂O₃ and 2-5 ZrO₂. The melting temperatures are reduced by the high alkali metal contents. However, these glasses are unable to satisfy high demands on the heat resistance and the temperature gradient strength, on account of their low viscosities and relatively high coefficients of thermal expansion.

U.S. Pat. No. 3,615,320 describes a chemically tempered flat glass which likewise has high alkali metal contents, with the drawbacks described above, the glass comprising, in % by weight, 59-62 SiO₂, 18-23 Al₂O₃, 4-5.5 Li₂O, 7-9 Na₂O, 3-5 B₂O₃. The document mentions As₂O₃, NaCl, Sb₂O₃, Al₂(SO₄)₃ as refining agents.

DE 42 06 268 C2 discloses a chemically temperable glass composition containing, in % by weight, 62-75 SiO₂, 5-15 Al₂O₃, 4-10 Li₂O, 4-12 Na₂O and 5.5-15 ZrO₂. In this case too, the high alkali metal contents are disadvantageous to the heat resistance and temperature gradient strength. Refining agents mentioned are As₂O₃, Sb₂O₃, F and Cl. The document does not give any indication of the production of a flat glass using the float process, and therefore, for example, of a refining agent compatible with the float process. The high ZrO₂ contents are disadvantageous in terms of the resistance to devitrification under the float process conditions.

A glass which can be produced by the float process and has a high heat resistance for use as fireproofing glass is disclosed in JP 2002047030A1. The glass can be thermally tempered and allows the production of a safety glass. The low Li₂O content of 0.5-2% by weight means that there are drawbacks for chemical tempering.

DE 100 17 701 C2 describes a flat float glass which can be tempered or converted into a glass-ceramic with beta-quartz solid solutions or keatite solid solutions.

The compositions disclosed have to contain TiO₂ or ZrO₂ as nucleating agents. Under the float process conditions, these glass-ceramic compositions are more critical in terms of their resistance to devitrification than glasses with low TiO₂ and ZrO₂ contents, which cannot be converted into the abovementioned glass-ceramics.

It is an object of the invention to provide lithium-aluminosilicate flat float glasses with a high heat resistance, which can be chemically and thermally tempered and are suitable for economical and environmentally friendly production.

The object is achieved by a lithium-aluminosilicate flat float glass having a composition which, based on the total composition, contains the following main constituents (in % by weight):

| | |
|---|---|
| Li₂O | 2.5-6.0 |
| Al₂O₃ | 15-30 |
| SiO₂ | 55-75 |

and with the composition, with regard to the viscosity-reducing components, being restricted to

| | | |
|---|---|---|
| Σ Na₂O + K₂O | <4% | by weight |
| B₂O₃ | 0-<4% | by weight |

and together with the nucleating additions which are customary for the production of glass-ceramics

| | |
|---|---|
| Σ TiO₂ + ZrO₂ | amounting to <2% by weight, in |
| | order to avoid the |
| | crystallization of undesirable |
| | beta-quartz and/or keatite solid |
| | solutions. |

The flat float glass in accordance with the invention has
a good bubble quality and environmentally friendly refining without using the refining agents arsenic oxide and/or antimony oxide that are otherwise customary,
a high heat resistance and temperature gradient strength
on account of its ability to be chemically and thermally tempered, a wide range of possible applications in which high demands are imposed on strength and/or scratch resistance,
a high rigidity and a high light transmission
a low density and good chemical resistance to water, acid and alkalis.

The glass is refined in the melt without using the refining agents arsenic oxide and/or antimony oxide which are customary for high-melting glasses, and contains 0.1-2.0% by weight of SnO₂ as chemical refining agent. The flat glass is shaped by being poured onto a liquid metal in a reducing atmosphere, i.e. using the standard float process.

Float glass installations usually comprise the melt tank, in which the glass is melted and refined, an interface which is responsible for the transition from the oxidic atmosphere in the melting tank to the reducing atmosphere of the downstream part of the installation, the float part, in which the glass is shaped by being poured onto a liquid metal, generally Sn, in a reducing atmosphere of forming gas. The glass is shaped by smooth flow on the Sn bath and by what are known as top rollers which exert a force on the glass surface. While it is being transported on the metal bath, the glass cools and at the end of the float section is lifted off and transferred into a cooling furnace.

While the glass surface is being formed and the glass is being transported in the float bath, interactions between glass melt, float atmosphere and the Sn bath can lead to disruptive surface defects. If the glass contains more than 2% by weight of TiO₂+ZrO₂, nuclei may form in the glass surface in contact with the Sn bath, and beta-quartz solid solutions with a size of up to a few 100 μm may crystallize at these nuclei, thereby producing disruptive surface crystallization. In the flat float glass according to the invention, which can be chemically and thermally tempered, the formation of these undesirable surface crystals during the float process is avoided by restricting the nucleating agents which are customary for the production of glass-ceramics to Σ TiO₂+ZrO₂<2% by weight. Therefore, the flat float glasses according to the invention are more resistant to devitrification but can no longer be converted into glass-ceramics.

The glass is restricted to less than 2% by weight of refining agent SnO₂. This is because the action of the forming gas in the float section partially reduces SnO₂ in the glass surface. At higher SnO₂ contents, small balls of metallic Sn with sizes of approx. 100 nm are formed directly in the surface of the glass. Although these can be removed during cooling or purification, spherical holes remain behind in the glass surface, which are extremely disruptive in use. Also, with higher SnO₂ contents, disruptive alloying effects with precious-metal fittings made from Pt and Pt/Rh may form. These materials are used in melt installations, in particular as electrodes, lining, stirring means, transfer tubes, slides, etc.

Li₂O constitutes a significant constituent for carrying out the chemical tempering process on the flat glass. During the chemical tempering, this component is exchanged in the glass surface layer for ions with a larger radius, primarily for sodium and/or potassium ions. On account of its very good diffusion, it allows high compressive stresses and relatively great thicknesses of the compressive-stress layer to be produced. This results in high strengths. The ion exchange can also be carried out at relatively low temperatures compared to exchange of Na in the glass for potassium. Contents of lower than 2.5% by weight are disadvantageous for the ion exchange properties. If the Li₂O content exceeds 6% by weight, the chemical resistance of the glass deteriorates. On account of the reduction in the transformation temperature T_{g} associated with the drop in viscosity, the heat resistance deteriorates. The increase in the coefficient of thermal expansion of the glass is disadvantageous for the temperature gradient strength.

The Al₂O₃ content should be between 15 and 30% by weight. The Al₂O₃ is involved in forming the glass skeleton. It promotes the diffusion of the alkali metal ions during the ion exchange and is therefore an important factor in promoting the ion exchange properties and therefore in achieving high strengths during chemical tempering. It should form less than 30% by weight, since otherwise the resistance to devitrification deteriorates and the melting temperatures and shaping temperatures during the float process rise.

SiO₂ is the main component which forms the glass skeleton. If it forms less than 55% by weight, the chemical resistance and the heat resistance deteriorate, since the thermal expansion of the glass rises and the transformation temperature T_{g} drops. Excessively high SiO₂ contents, greater than 75% by weight, increase the melting point and the shaping temperature during production. These increased temperatures are technically and economically disadvantageous for melting and floating, since they impose higher demands on the installation parts.

The alkaline metals Na₂O, K₂O and B₂O₃ are often added to float glasses in order to lower the viscosity and thereby reduce the melting temperature and shaping temperatures. This is economically advantageous and sufficient for many applications which do not depend on a high heat resistance. In the present invention, however, the contents of these metals are limited to Σ Na₂O+K₂₀<4% by weight, since here it is additionally desirable to achieve applications in which a high heat resistance and temperature gradient strength are important. This makes it possible to increase the transformation temperature Tg and to keep the coefficient of thermal expansion at a low level.

The B₂O₃ content should not exceed 4% by weight, since otherwise the transformation temperature becomes too low. Higher B₂O₃ contents are also not compatible with the high Al₂O₃ contents of the flat glass in accordance with the invention, since both components have an unfavourable influence on the melting properties and the resistance to devitrification.

The water content of the glasses according to the invention, depending on the choice of raw materials for the batch and on the process conditions, is usually between 0.01 and 0.06 mol/l in the melt.

The lithium-aluminosilicate flat glass according to the invention opens up application areas which require a high heat resistance and are not readily available to soda-lime glasses or borosilicate glasses. The composition ranges indicated represent a compromise between the high heat resistance and economic production via melt and shaping by the float process. The glasses can be melted at melting temperatures of approx. 1600 to 1650° C. with acceptable throughputs and can be produced on an industrial scale on float installations with only minor modifications. Devitrification and other surface defects can be controlled by technical means, and the refining is effected not by standard sulphate or chloride refining, but rather by the high-temperature refining agent SnO₂ as the main refining agent.

The particular economic advantage of the said glass composition range is that according to the invention the same composition can be used to produce flat glasses which can be tempered both thermally and chemically. This allows difficult and time-consuming melt changeover between different compositions to be avoided. This also simplifies manufacturing logistics, for example in terms of the raw materials used for the batch and the charge cullet which needs to be held in stock. The various products can be produced from the stored glass according to the market demand by subsequent processing. In this context, the thermal and chemical tempering complement one another in terms of their property profiles and allow various requirements to be optimally implemented.

The technically more complex chemical tempering allows higher compressive stresses and therefore also higher strengths to be achieved in the glass surface. The thickness of the compressive-stress layer at the surface is in this case up to a few 100 μm, and generally less than in the case of thermal tempering. In this context, it is advantageous that, unlike in the case of thermal tempering, it is also possible to temper flat glasses with a thickness of less than approx. 3 mm.

On account of their higher strength and scratch resistance, chemically tempered flat glasses are used for applications which are subject to particularly high demands, for example in aerospace or aeronautical glazing, as clock glass, boiler viewing glass, for centrifuge glasses and in the illumination sector, and also as safety glass. The tensile stresses in the interior of chemically tempered glasses are lower than in the case of thermally tempered glasses. In principle, the tensile stresses in the interior of the glass decrease with the thickness of the flat glass. If the tensile stresses remain below the strength limit, the chemically toughened flat glasses can even be machined.

Thermal tempering is highly economical on account of the short process times. The increase in strength achieved is sufficient for many applications, for example for use as thermally toughened fireproof safety glass. The thickness of the compressive-stress layer at the surface of the glass is in principle greater than in the case of chemical tempering.

In one preferred embodiment, the lithium-aluminosilicate flat float glass is chemically tempered by an ion exchange process with an ion which has a larger ion radius. As a result, the flat glass has a lower lithium concentration and an increased concentration of the cation which has been exchanged for Li at the surface. It is preferable for the lithium to be exchanged for sodium and/or potassium ions, so that there are increased levels of the latter ions at the surface, thereby producing a compressive-stress layer on account of these ions taking up a greater amount of space.

If the ion exchange is carried out by exchanging sodium ions for the lithium ions in the glass, it is possible to produce greater compressive-stress layers, at the same exchange temperatures and times, than if potassium ions are used. The reason for this is the higher diffusion ability of the sodium ion compared to the potassium ion. Ion exchange by potassium ions leads to thinner compressive-stress layers, which have higher compressive stresses at the surface, under the same process conditions.

If the ion exchange is effected by a combination of sodium and potassium ions in a common tempering process or in succession, it is even possible to produce compressive-stress profiles comprising a plurality of zones. By way of example, it is possible to realize a compressive-stress profile in which a surface zone with a high compressive stress and a thickness of from 10 to 40 μm is adjoined towards the inside by a second zone which is few 100 μm thick and has a lower compressive stress. A compressive-stress profile of this type is favourable for Knoop hardness and strength and makes the tempered flat glass unsusceptible to damage, since even relative large notch cracks cannot penetrate as far as the tensile stress zone in the interior of the glass, where they would then cause a fracture to occur.

The compressive-stress profile can be optimized for the particular demands by suitable selection of the cations which are exchanged and by means of the process conditions. The chemically tempered flat glasses can be mechanically machined (cutting, drilling, edge-machining) or have safety glass properties, with the fragmentation appearance required by DIN 1249, as a function of the thickness of the flat glass and the compressive-stress profile which is set, as well as the tensile stress in the interior of the glass.

This opens up further application areas for chemically tempered glasses, which were previously reserved only for thermally tempered glasses.

In process engineering terms, the ion exchange can be carried out in a treatment bath comprising a molten salt, or alternatively solutions or pastes are applied to the glass surface. Suitable compounds for the ion exchange are nitrates, sulphates, bisulphates, carbonates, bicarbonates and halides, as well as double salts. Mixtures of the abovementioned compounds can also be used. The compounds for the ion exchange are selected as a function of the process engineering parameters, such as temperature and time of ion exchange, the desired compressive-stress profile, the required increase in strength and also such that the ion exchange process does not attack the surface of the glass and adhering compound residues can easily be removed.

If the ion exchange is carried out by molten salts which contain nitrates, it is necessary to take account of the decomposition temperature of the nitrates. Decomposition can have an adverse affect on the surface quality of the glass and release vapours which are harmful to health. Therefore, nitrate/nitride treatment baths can be used in a technologically suitable way up to temperatures of approximately 430° C. Admixing the corresponding sulphate compounds to the molten nitrate salts allows the permissible exchange temperature to be increased.

If chloride salts are used in the exchange medium, these salts may attack the glass surface at higher concentrations and temperatures.

The ion exchange can be accelerated in a known way by applying an electric field during the ion exchange process.

According to the prior art, the compound which is suitable for the ion exchange can also be applied to the glass surface as a solution or paste instead of a molten salt by means of known coating processes. In addition to the pulverulent compound, the paste may also contain a powder of an inert medium, such as for example oxides of iron, titanium or silicon. Mineral compounds, such as for example feldspars, can also be admixed. The ion exchange takes place as a solid-state reaction. The advantages of the process and suitable process parameters are disclosed in DE 3 840 071 C2 and the exemplary embodiments.

As has already been explained above, the chemically temperable flat glass of the present invention, within the composition ranges indicated, has an excellent ability for ion exchange. In a preferred embodiment, the compressive-stress layer produced by ion exchange at the surface of the glass is at least 20 μm thick, preferably more than 200 μm thick, with the result that the chemically tempered flat glass has a high strength.

The compressive stress in the surface of the chemically tempered flat glass is advantageously more than 80 MPa, preferably more than 200 MPa. The high compressive stresses lead to the desired high strength and also a high Knoop hardness and therefore an improved scratch resistance.

A chemically tempered flat glass with particularly expedient application properties has ion exchange times of from 15 minutes to 100 hours, preferably less than 50 hours, and is treated at temperatures of from 300 to 650° C., but below the transformation temperature T_{g} of the glass. If the ion exchange is carried out at temperatures in the vicinity of the transformation temperature Tg or even above it, the compressive stresses which have been applied can already start to relax, thereby reducing the effect of the increase in strength. The relaxation already starts to manifest itself from approximately 100° C. below Tg.

The compressive-stress profile in the glass surface can be set by selecting the temperature and time of ion exchange. For example, extended exchange times at the same temperature lead to a thicker compressive-stress layer with a reduced level of the compressive stress directly at the glass surface.

The chemically tempered flat float glasses according to the invention preferably have a tensile bending strength of greater than 300 MPa, preferably greater than 600 MPa, and as a result have an excellent resistance to destruction.

In a second, alternative configuration of the invention, the flat float glass is thermally tempered.

The thermal tempering can be carried out by various media, for example by immersion in oil-covered water. However, this is technically more complex and also significantly more expensive than quenching in air in conventional air tempering installations. Therefore, it is preferable for the flat glass according to the invention to be heated to a temperature above Tg and thermally tempered by blowing cold air onto it. The thermal tempering by blowing air onto the glass is a particularly economic method for the production of safety glasses, for example for fire-retardant applications or for looking through, for example as boiler viewing glasses. The thermal tempering process is preferably carried out in such a way that the flat glass has a surface compressive stress of >40 MPa, more preferably of >120 MPa, and the thickness of the compressive-stress layer is greater than 200 μm, preferably greater than 500 μm. This produces the safety glass properties which are required for the fragmentation image in accordance with DIN 1249.

The flat float glass preferably has a coefficient of thermal expansion α_{20/300} of between 3.5 and 5.0·10⁻⁶/K, a transformation temperature Tg of between 580° C. and 720° C. and a working point V_{A} of between 1240 and 1340° C. If the coefficient of thermal expansion is below 3.5·10⁻⁶/K, it is difficult to achieve a compressive prestress which is sufficient for the fragmentation fracture in accordance with DIN 1249 using conventional air tempering installations. To achieve a high temperature gradient strength, the coefficient of thermal expansion α_{20/300} should be no more than 5.0·10⁻⁶/K. The transformation temperature Tg of the flat float glass should be between 580 and 720° C. These high transformation temperatures compared to standard soda-lime or borosilicate glasses have a positive effect on achieving a high thermal stability and high compressive prestress and therefore strength. The transformation temperature should not exceed 720° C., since otherwise tempering installations which are significantly more technically complex are required. The working point VA is below 1340° C. in order to facilitate melting and to limit the thermal load on the float bath. The working point VA is above 1240° C., in order to achieve the desired high thermal stability. This is advantageous, for example, for fire-retardant applications, to ensure that the glass does not flow out of the flame or bulge out excessively.

The compressive stress at the glass surface produced by the thermal or chemical tempering counteracts the formation of scratches or cracks as a result of the external action of force, since first of all the compressive stress has to be reduced before the surface can be damaged. This increases the scratch resistance of the tempered glasses. Chemical tempering is particularly effective here, since it can produce particularly high compressive stresses in the glass surface. A preferred embodiment of the flat float glass has a high scratch resistance with a Knoop hardness of >500, preferably >550.

For applications in which a low weight of the glass component is desired, for example in aerospace or aeronautical glazing and traffic engineering, it is advantageous if the flat glass used has a low density. To satisfy these requirements, the glass should have a density of less than 2.5 g/cm³, preferably less than 2.42 g/cm³.

For many applications in glazing or as a substrate, for example for hard disks, it is advantageous for the glass to have a high rigidity. To satisfy these requirements, the modulus of elasticity should have values of E>70 GPa, preferably >80 GPa.

By virtue of a good chemical resistance to water, acids and alkalis, the flat float glasses according to the invention can also be used for applications which impose high demands in this respect, for example under the action of chemically aggressive solutions or atmospheres. The hydrolytic resistance in accordance with DIN ISO 719 should be Class 1, the alkali resistance in accordance with DIN ISO 695 should be at least Class 2, and the acid resistance in accordance with DIN 12116 should be at least Class 3.

In a preferred embodiment of the invention, the flat float glass has a composition which, in % by weight based on the total composition, contains the following main constituents (in % by weight):

| | |
|---|---|
| Li₂O | 3.0-6.0 |
| Σ Na₂O + K₂O | <2 |
| Σ MgO + CaO + SrO + BaO | <4 |
| ZnO | 0-1.5 |
| B₂O₃ | 0-<4 |
| Al₂O₃ | 18-28 |
| SiO₂ | 60-72 |
| Σ TiO₂ + ZrO₂ | <2 |
| SnO₂ | 0.1-2.0 |
| | (as refining agent) |
| F | 0-2 |
| P₂O₅ | 0-3. |

This composition has a particularly good thermal stability combined, at the same time, with good tempering properties.

To achieve a preferred objective of the invention, namely that of providing a flat glass which has particularly favourable combinations of properties both for the float production process and for a wide range of applications, the coefficient of thermal expansion α_{20/300} should be between 3.8 and 4.5·10⁻⁶/K, the transformation temperature Tg should be between 600 and 680° C., and the V_{A} should be between 1280 and 1320° C. According to this preferred embodiment, the flat float glass has a composition which, in % by weight based on the total composition, contains the following main constituents:

| | |
|---|---|
| Li₂O | 3.5-5.0 |
| Σ Na₂O + K₂O | <1.5 |
| Σ MgO + CaO + SrO + BaO | <3 |
| ZnO | 0-1.0 |
| B₂O₃ | 0-<3 |
| Al₂O₃ | 19-26 |
| SiO₂ | 62-70 |
| Σ TiO₂ + ZrO₂ | <1.5 μm in order to |
| | avoid the |
| | crystallization of |
| | undesirable beta- |
| | quartz and/or keatite |
| | solid solutions |
| SnO₂ | 0.1-1.0 |
| | as refining agent |
| F | 0-1.8 |
| P₂O₅ | 0-2. |

The addition of fluorine has proven particularly technically advantageous in order to reduce the working point V_{A} in flat glasses having the composition ranges indicated and to lower an excessively high transformation temperature T_{g}. In this context, it is particularly advantageous that the coefficient of thermal expansion is thereby reduced slightly. This effect runs counter to the effects of the mostly viscosity-reducing additions, such as for example the alkali metal or alkaline-earth metal oxides. Its strong effect means that only relatively small amounts of fluorine need be added. In a preferred embodiment, the fluorine content is 0.1-1.2% by weight, based on the total composition. Fluorine contents of higher than 1.2% by weight are disadvantageous, since they have an adverse effect on the chemical resistance of the glass and since the compressive stress in thermally tempered glasses relaxes at lower temperatures.

The environmental problems which apply to the chemical refining agents arsenic oxide and/or antimony oxide also apply, albeit to a lesser extent, to barium oxide. Barium-containing raw materials, in particular if they are water-soluble, such as barium chloride and barium nitrate, are toxic and require special precautionary measures to be taken in use. In the flat glasses according to the invention, it is advantageously possible to make do without the addition of BaO, apart from technically inevitable traces.

To achieve particularly good bubble qualities, it may be advantageous to add at least one further chemical refining auxiliary compatible with the float process in addition to the refining agent SnO₂ used, for example cerium oxide, sulphate compounds, chloride compounds or fluorine compounds. Alternatively, the flat glass may also be formed in such a way that to achieve a low number of bubbles the glass melt is refined by physical means, for example by means of reduced-pressure refining or by means of high-temperature refining >1680, preferably >1730° C. If there are particularly high demands imposed on the bubble quality, it may be necessary to combine chemical refining and physical refining processes.

It is possible for some of the Al₂O₃, up to approx. 4% by weight, to be replaced by chemically related trivalent oxides, in particular La₂O₃ and Y₂O₃. This allows melting and devitrification properties and modulus of elasticity to be improved, but does incur higher raw materials costs.

A high light transmission is typically required for applications of the glass, for example for glazing as, for example, fireproof safety glass. The glass should also have as little inherent colour as possible, i.e. the colour locus should be in the vicinity of the achromatic point. Relevant standards to the use of fireproof safety glass in the construction sector require a light transmission, at a thickness of 4 mm, of >90%. It has been found that the required light transmission, at a thickness of 4 mm, of >90, preferably >91%, can be achieved according to one configuration of the invention by using an Fe₂O₃ content of less than 250 ppm and a TiO₂ content of less than 1% by weight.

In situations in which the flat float glass is intended to provide protection against UV or infrared radiation, it may be advantageous for UV- or IR-absorbing additives to be added to the flat glass in amounts of typically <1% by weight. This may be necessary, for example, if the flat glass is used outdoors and is to provide protection against UV radiation from the sun. Likewise, in the illumination sector the light source may emit UV or IR radiation. UV radiation may be harmful to health or may lead to the embrittlement of plastic seals in constructions in which such seals are employed. Examples of UV- or IR-absorbing additives used include iron oxide, selenium oxide, cerium oxide, nickel oxide, cobalt oxide, copper oxide, titanium oxide.

To reduce any colour cast which may be present and to shift the colour locus to close to the achromatic point, it is advantageously possible to add decolourizing agents, such as for example manganese oxide and/or selenium oxide, to the flat glass.

It is likewise possible to add colour-change agents, such as for example cobalt oxide, nickel oxide, chromium oxide or rare earth oxides. Whereas the action of the decolourizing agents is based, for example, on the colour cast caused by Fe₂O₃ contamination of the raw materials being reduced, the effect of the colour-change agents is based on the fact that these agents absorb in regions of the visible spectrum in which, for example, the Fe₂O₃ does not absorb. As a result, the flat glass appears colour-neutral to the observer, although in the colour-change method the overall light transmission is reduced, and the glass acquires a slight, scarcely perceptible grey hue. Additions of UV-absorbing and/or IR-absorbing substances may also produce a colour cast, which can be reduced by decolourizing or colour-change agents.

For special glazing, for example as filter glass in illumination technology or to achieve certain design effects, it is in some cases also desirable to colour glasses. For applications of this nature, the flat float glass according to the invention may be coloured using standard colouring agents, such as for example vanadium, chromium, iron, copper and nickel compounds, so that the light transmission at a thickness of 4 mm is <80%.

If coating of the flat glass is desired, it is economically advantageous to utilize the residual heat of the glass from the float process and to effect this coating in the float section and/or before cooling of the glass. It is in this way possible for one or more layers, for example of SiO₂, TiO₂, SnO₂, Al₂O₃, WO₃, VO₂ or conductive indium/SnO layers, to be applied.

The high surface quality of the float process results in aesthetic advantages in the flat glasses. Star shapes and light reflections when the glasses are looked at and distortion when they are looked through are avoided. The glasses can be used without expensive polishing of the surface. If they are used, for example, as chimney viewing windows, oven viewing windows or in the illumination sector, and also in glazing, the float surface is much less susceptible to adhering contamination and can be cleaned more easily than, for example, a surface produced by roller shaping, with its associated micro-roughness.

The flat float glass according to the invention, after thermal or chemical tempering, is preferably used for applications which impose high demands on the strength and/or scratch resistance, such as for example as a safety glass in aeronautical or aerospace glazing, as well as in traffic engineering, as boiler viewing glass, centrifuge glass, clock glass, as a cover in scanner appliances, as a hard disk memory substrate and for the glazing of rooms in which there is a high temperature gradient between the inside and outside. On account of its high thermal stability, the glass is advantageously also suitable for uses in the illumination sector, as fireproof glazing or as oven or chimney viewing windows.

The present invention is explained further with the aid of the following examples.

Table 1 lists compositions and properties of flat float glasses for a number of exemplary embodiments. Examples 1 to 10 are glasses according to the invention, and Examples 11 and 12 are comparative examples which lie outside the scope of the present invention. Table 2 compares the process parameters used during chemical tempering and the resulting properties of the associated glasses.

The starting glasses from Table 1 were melted and refined at temperatures of 1620° C. using raw materials employed as standard in the glass industry. After melting in crucibles made from sintered silica glass, the melts were transferred into platinum crucibles and homogenized by stirring for 30 minutes at temperatures of 1550° C. After standing at 1640° C. for 2 hours, castings of a size of approx. 140×100×30 mm were cast and cooled to room temperature in a cooling furnace starting from approx. 670° C., in order to reduce thermally induced stresses. The test specimens, for example bars for measuring the coefficient of thermal expansion and the transformation temperature Tg, and plates for the tempering tests, were prepared from these castings.

Analysis reveals that approx. 10-30% of the fluorine evaporates from the batch used. The values in Table 1 correspond to the fluorine contents remaining in the glasses. The water content of the glasses is determined by infrared measurement and is between 0.015 and 0.040 mol/l. The iron content caused by the batch raw materials used is between 100 and 150 ppm in the examples.

The density, the transformation temperature Tg, the working point V_{A}, the coefficient of thermal expansion in the temperature range between 20 and 300° C., the light transmission τ in the visible light region for a thickness of 4 mm and the modulus of elasticity were determined for the melted glasses.

The chemical resistance of the glasses was measured (hydrolytic resistance in accordance with DIN ISO 719, alkali resistance in accordance with DIN ISO 695 and acid resistance in accordance with DIN 12116).

As can be seen from Table 1, glasses 1 to 10 in accordance with the invention satisfy the requirements imposed on the flat float glass.

By contrast, comparative example 11, taken from patent DE 42 06 268 C2, Example 4, compared to the glasses according to the invention, on account of its composition has a relatively low viscosity, the transformation temperature Tg is low, and the coefficient of thermal expansion is also increased, which means that this glass is relatively unsuitable for uses in which a high thermal stability is required. The glass composition in comparative example 12 corresponds to a commercially available, chemically temperable glass composition, and on account of its high Na₂O and K₂O contents, likewise has the drawback of a low thermal stability associated with the high coefficient of thermal expansion.

Glasses from Table 1 were chemically tempered in accordance with the examples given in Table 2. Table 2 shows the process parameters used during tempering by ion exchange in salt baths and by applied pastes. In Example 29, the chemical tempering was carried out using a paste comprising equal amounts of pulverulent potassium sulphate and orthoclase. The pulverulent constituents were stirred into a sprayable paste using a paste-forming oil which can be burnt out and ethanol as liquefier. In Example 31, the paste comprises equal powder contents of potassium sulphate, sodium sulphate and orthoclase. The powder mixture was stirred with paste-forming oil and ethanol. After the paste had been applied to the glass plates, the latter were treated at the temperatures and times indicated in order to carry out the ion exchange.

The Knoop hardness is determined on tempered specimens in accordance with DIN ISO 9385.

The thickness of the compressive-stress layer is measured by photoelastic examination on 1 mm thick plates polished prior to the tempering. The measured surface compressive stress is converted using the photoelastic constant. For example, in Example 13 with a photoelastic constant of 3.0*10⁻⁶ mm²/N, the measured surface compressive stress is 8610 nm/cm, and the conversion results in a compressive stress of 286 MPa (cf. Table 2). In the interior of the glass, the tensile stress, after conversion, is 26 MPa.

For selected glasses, the mean tensile bending strength was measured on tempered plates with dimensions of 50 mm×50 mm×5 mm by means of the double-ring method in accordance with DIN EN 1288-5. The plates have very high tensile bending strengths.

In Example 32, the compressive-stress profile listed specifically in the invention is produced by chemical tempering in a salt bath consisting of sodium and potassium salts. In the first 12 μm-wide zone at the surface of the glass specimen, the compressive stress is 368 MPa, and in the second, 490 μm-thick zone towards the interior of the glass, the compressive stress is 225 MPa.

### EXAMPLE 33

In this example, which is not listed in Table 2, four plates with dimensions of 250 mm×250 mm×5 mm were prepared from glass No. 9 of Table 1 and polished on both sides. The plates were thermally tempered in a tempering furnace by heating to 700° C. followed by cold air being blown onto them.

Then, the fire resistance time was tested in a fire test for 120 min compared to a likewise thermally tempered alkali metal borosilicate glass of the same dimensions. The test conditions were identical for both glass types.

As expected, premature failure did not occur for either of the glasses; it was only possible to determine major differences in the deformation—caused by the flow and subsequent bulging of the panes: the maximum deformation in the case of the alkali metal borosilicate glass was between 24 and 28 mm, whereas that of the glass from Example 31 was only 6 mm. Such low deformation values allow very long resistance to fire to be achieved.

Further thermally tempered specimens of the example glass—likewise with dimensions of 250 mm×250 mm×5 mm—were subjected to the fragmentation test in accordance with DIN 1249, in which the number of fragments in a defined counting mask, the surface area of the largest fragment and its length are recorded. The standard requirement is for at least 30 pieces per 100 cm².

In a count area of 5 cm×5 cm there were 28 fragments; extrapolated to the standard area, therefore, this means 112 fragments. The requirements of DIN 1249 are therefore far exceeded by the glass compositions according to the invention.

TABLE 1
compositions and properties of glasses

| | Examples No. | | | | | |
|---|---|---|---|---|---|---|
| | 1 | 2 | 3 | 4 | 5 | 6 |
| | Glass No. | | | | | |
| | 1 | 2 | 3 | 4 | 5 | 6 |
| Composition | | | | | | |
| SiO₂ (% by weight) | 66.5 | 67.0 | 66.3 | 67.0 | 66.3 | 66.3 |
| Al₂O₃ (% by weight) | 23.4 | 24.0 | 23.4 | 23.5 | 23.35 | 23.4 |
| Li₂O (% by weight) | 4.25 | 4.2 | 4.2 | 4.25 | 4.2 | 4.2 |
| Na₂O (% by weight) | 0.5 | 1.0 | 0.8 | 0.6 | 0.5 | 0.8 |
| K₂O (% by weight) | 0.15 | — | — | 0.25 | 0.15 | — |
| MgO (% by weight) | 1.6 | 1.0 | 0.8 | 1.3 | 1.6 | 1.3 |
| CaO (% by weight) | — | 1.0 | 0.5 | — | — | 0.5 |
| ZnO (% by weight) | 0.6 | 0.6 | — | 0.6 | 0.6 | — |
| TiO₂ (% by weight) | — | — | — | — | — | — |
| ZrO₂ (% by weight) | 1.0 | 0.7 | 0.5 | 1.0 | 1.0 | 1.0 |
| P₂O₅ (% by weight) | 0.8 | — | — | — | 0.8 | — |
| SNO₂ (% by weight) | 0.5 | 0.5 | 0.5 | 0.5 | 0.5 | 0.5 |
| B₂O₃ (% by weight) | — | — | 3.0 | — | — | 2.0 |
| SrO (% by weight) | — | — | — | 1.0 | — | — |
| F (% by weight) | 0.7 | — | — | — | 1.0 | — |
| Glass properties: | | | | | | |
| Density (g/cm³) | 2.406 | 2.420 | 2.379 | 2.424 | 2.409 | 2.382 |
| Tg (° C.) | 645 | 708 | 680 | 706 | 633 | 682 |
| V_{A} (° C.) | 1307 | 1323 | 1305 | 1332 | 1298 | 1325 |
| α_{20/300} (10⁻⁶/K) | 4.16 | 4.46 | 4.28 | 4.41 | 4.13 | 4.34 |
| Light transmission 4 mm | 90.1 | 91.3 | 91.4 | 89.7 | 91.5 | 91.5 |
| thickness, τ (%) | | | | | | |
| Modulus of elasticity (GPa) | 85 | 86 | 82 | 87 | 85 | 84 |
| Chemical resistance: | | | | | | |
| Hydrolytic resistance | 1 | 1 | 1 | 1 | 1 | 1 |
| Acid resistance | 3 | 3 | 3 | 2 | 2 | 4 |
| Alkali resistance | 1 | 1-2 | 2 | 1 | 1 | 2 |
| | Examples No. | | | | | |
| | 7 | 8 | 9 | 10 | 11 | 12 |
| | Glass No. | | | | | |
| | 7 | 8 | 9 | 10 | 11 | 12 |
| Composition | | | | | | |
| SiO₂ (% by weight) | 65.5 | 67.3 | 67.5 | 67.4 | 68.00 | 62.6 |
| Al₂O₃ (% by weight) | 23.2 | 23.6 | 23.4 | 23.4 | 13.00 | 16.55 |
| Li₂O (% by weight) | 4.2 | 4.3 | 4.25 | 4.2 | 8.00 | |
| Na₂O (% by weight) | 0.8 | 0.6 | 0.5 | 0.55 | 5.00 | 12.9 |
| K₂O (% by weight) | — | 0.1 | 0.15 | 0.1 | | 3.5 |
| MgO (% by weight) | 1.3 | 1.7 | 1.6 | 1.7 | | 3.3 |
| CaO (% by weight) | 0.5 | — | — | 0.2 | | 0.3 |
| ZnO (% by weight) | — | — | 0.6 | 0.4 | | |
| TiO₂ (% by weight) | — | — | — | — | — | 0.8 |
| ZrO₂ (% by weight) | 1.0 | 1.0 | — | — | 6.00 | |
| P₂O₅ (% by weight) | — | — | 0.8 | 0.7 | | |
| SNO₂ (% by weight) | 0.5 | 0.6 | 0.5 | 0.5 | | 0.05 |
| B₂O₃ (% by weight) | 2.0 | — | — | | | |
| SrO (% by weight) | — | — | — | | | |
| F (% by weight) | 0.8 | 0.8 | 0.7 | 0.85 | | |
| Glass properties: | | | | | | |
| Density (g/cm³) | 2.391 | 2.424 | 2.392 | 2.3956 | 2.455 | 2.431 |
| Tg (° C.) | 621 | 674 | 646 | 660 | 504 | 623 |
| V_{A} (° C.) | 1298 | 1301 | 1312 | 1324 | 1078 | 1310 |
| α_{20/300} (10⁻⁶/K) | 4.30 | 4.02 | 4.25 | 4.17 | 7.36 | 8.33 |
| Light transmission 4 mm | 91.6 | 91.4 | 91.3 | 91.0 | n.d. | n.d. |
| thickness, τ (%) | | | | | | |
| Modulus of elasticity (GPa) | 82 | n.d. | 85 | 85 | 86 | 72 |
| Chemical resistance: | | | | | | |
| Hydrolytic resistance | 1 | 1 | 1 | 1 | n.d. | n.d. |
| Acid resistance | 3 | 3 | 2 | 2-3 | n.d. | n.d. |
| Alkali resistance | 2 | 1 | 2 | 2 | n.d. | n.d. |

TABLE 2
Process conditions during tempering, and properties of tempered glasses

| Examples No. | | | | | | | |
|---|---|---|---|---|---|---|---|
| 13 | 14 | 15 | 16 | 17 | 18 | 19 | 20 |
| Glass No. | | | | | | | |
| 1 | 1 | 1 | 1 | 1 | 10 | 10 | 10 |

Tempering conditions:

| | | | | | | | | |
|---|---|---|---|---|---|---|---|---|
| Chemical | Na nitrate | 29.5% by | 29.5% by | 29.5% by | 87.75% by | Na nitrate | Na nitrate | 87.75% by |
| tempering | salt bath | weight Na | weight Na | weight Na | weight K | salt bath | salt bath | weight K |
| | | sulphate | sulphate | sulphate | nitrate | | | nitrate |
| | | 70.5% by | 70.5% by | 70.5% by | 12.25% by | | | 12.25% by |
| | | weight Na | weight Na | weight Na | weight K | | | weight K |
| | | nitrate | nitrate | nitrate | sulphate | | | sulphate |
| | | salt bath | salt bath | salt bath | salt bath | | | |
| Temperature T | 405° C. | 520° C. | 520° C. | 500° C. | 520° C. | 405° C. | 405° C. | 520° C. |
| Exchange time t | 16 h | 4 h | 8 h | 4 h | 16 h | 16 h | 40 h | 16 h |

Properties of tempered glasses:

| Knoop hardness | 610 | 580 | 570 | 580 | 615 | 610 | 610 | 810 |
|---|---|---|---|---|---|---|---|---|
| HK 0.1/20 | | | | | | | | |
| Tensile bending | 754 | n.d. | n.d. | n.d. | n.d. | n.d. | n.d. | 890 |
| strength σ_{B} | | | | | | | | |
| (MPa) | | | | | | | | |
| Surface | 286 | 229 | 161 | 284 | 533 | 251 | 194 | 600 |
| compressive | | | | | | | | |
| stress (MPa) | | | | | | | | |
| Thickness of | 300 | 550 | 770 | 400 | 30 | 340 | 470 | 30 |
| the | | | | | | | | |
| compressive- | | | | | | | | |
| stress layer | | | | | | | | |
| (μm) | | | | | | | | |
| | Examples No. | | | | | | | |
| | 21 | 22 | 23 | 24 | 25 | 26 | 27 | 28 |
| | Glass No. | | | | | | | |
| | 2 | 3 | 4 | 5 | 6 | 7 | 8 | 9 |

Tempering conditions:

| | | | | | | | | |
|---|---|---|---|---|---|---|---|---|
| Chemical | Na nitrate | Na nitrate | Na nitrate | Na nitrate | Na nitrate | Na nitrate | Na nitrate | Na nitrate |
| tempering | salt bath | salt bath | salt bath | salt bath | salt bath | salt bath | salt bath | salt bath |
| Temperature T | 405° C. | 405° C. | 405° C. | 405° C. | 405° C. | 379° C. | 405° C. | 405° C. |
| Exchange time t | 64 h | 16 h | 64 h | 16 h | 40 h | 40 h | 16 h | 40 h |

Properties of tempered glasses:

| | | | | | | | | |
|---|---|---|---|---|---|---|---|---|
| Knoop hardness | n.d. | 620 | 600 | 520 | 560 | 570 | 650 | 590 |
| HK 0.1/20 | | | | | | | | |
| Tensile bending | n.d. | 700 | n.d. | n.d. | n.d. | n.d. | 654 | 624 |
| strength σ_{B} | | | | | | | | |
| (MPa) | | | | | | | | |
| Surface | 151 | 263 | 177 | 355 | 165 | 258 | 310 | 215 |
| compressive | | | | | | | | |
| stress (MPa) | | | | | | | | |
| Thickness of | 770 | 340 | 740 | 310 | 540 | 390 | 330 | 600 |
| the | | | | | | | | |
| compressive- | | | | | | | | |
| stress layer | | | | | | | | |
| (μm) | | | | | | | | |

| Examples No. | | | |
|---|---|---|---|
| 29 | 30 | 31 | 32 |
| Glass No. | | | |
| 9 | 9 | 9 | 9 |

Tempering conditions:

| | | | | |
|---|---|---|---|---|
| Chemical | K paste | 87.75% by weight K | K/Na mixed paste | 21% by weight Na nitrate |
| tempering | | nitrate | | 57% by weight K nitrate |
| | | 12.25% by weight K | | 11% by weight Na sulphate |
| | | sulphate | | 11% by weight K sulphate |
| | | salt bath | | salt bath |
| Temperature T | 520° C. | 520° C. | 460° C. | 405° C. |
| Exchange time t | 40 h | 16 h | 16 h | 16 h |

Properties of tempered glasses:

| | | | | |
|---|---|---|---|---|
| Knoop hardness HK | 605 | n.d. | 605 | 580 |
| 0.1/20 | | | | |
| Tensile bending | | n.d. | n.d. | n.d. |
| strength σ_{B} (MPa) | | | | |
| Surface | 74 | 604 | n.d. | 368 (in 1st zone, at |
| compressive | | | | surface, 12 μm thick) |
| stress (MPa) | | | | 225 (in 2nd zone beneath |
| | | | | it, 490 μm thick) |
| Thickness of the | 30 | 30 | n.d. | 12 μm (1st zone at |
| compressive- | | | | surface) |
| stress layer (μm) | | | | 502 μm (total thickness) |

1-28. (canceled)

29. A lithium-aluminosilicate flat float glass with a high thermal stability, which can be chemically and thermally tempered and is refined without using the standard refining agents arsenic oxide and/or antimony oxide, having a composition which, in % by weight based on the total composition, comprising:

| | |
|---|---|
| Li₂O | 2.5-6.0 |
| Σ Na₂O + K₂O | <4 |
| B₂O₃ | 0-<4 |
| Al₂O₃ | 15-30 |
| SiO₂ | 55-75 |
| Σ TiO₂ + ZrO₂ | <2 (in order to avoid the crystallization of |
| | undesirable beta-quartz and/or keatite |
| | solid solutions). |

30. The flat float glass according to claim 29, further comprising 0.1-2.0% by weight of SnO₂ as chemical refining agent.

31. The flat float glass according to claim 29, wherein it is chemically tempered by ion exchange in which lithium at the surface is exchanged for an ion with a larger ion radius, and as a result the surface has a lower lithium concentration than the volume.

32. The flat float glass of claim 31, wherein said ion with a larger ion radius is a sodium or potassium ion.

33. The flat float glass according to claim 31, wherein the ion exchange is effected by Na ions.

34. The flat float glass according to claim 31, wherein the ion exchange is effected by a combination of Na and K ions in a common tempering process or in succession, and wherein the tempered flat glass has a compressive stress profile with a plurality of zones of different stress levels.

35. The flat float glass according to claim 31, wherein the thickness of the compressive-stress layer produced by ion exchange is at least 20 μm.

36. The flat float glass according to claim 35, wherein said thickness is more than 200 μm.

37. The flat float glass according to claim 31, wherein the surface compressive stress is >80 MPa.

38. The flat float glass according to claim 37, wherein said surface compressive stress is >200 MPa.

39. The flat float glass according to claim 31, wherein the chemical tempering is carried out over the course of 15 min-100 hours at temperatures of from 300 to 650° C., below the transformation temperature T_{g} of the glass.

40. The flat float glass according to claim 31, having a tensile bending strength of >300 MPa.

41. The flat float glass according to claim 31, having a tensile bending strength of >600 MPa.

42. The flat float glass according to claim 29, wherein the flat glass is thermally tempered.

43. The flat float glass according to claim 42, wherein the thermal tempering is carried out by heating to a temperature of approximately 50 to 120° C. above the transformation temperature Tg of the glass and blowing air onto the glass.

44. The flat float glass according claim 42, wherein the surface compressive stress is >40 MPa and the thickness of the compressive-stress layer is >200 μm.

45. The flat float glass according to claim 29, having a coefficient of thermal expansion α_{20/300} of between 3.5 and 5.0·10⁻⁶/K, a transformation temperature Tg of between 580 and 720° C., and a working point V_{A} of between 1240-1340° C.

46. The flat float glass according to claim 29, having a high scratch resistance with the Knoop hardness being >500.

47. The flat float glass according to claim 29, having a density of less than 2.5 g/cm³.

48. The flat float glass according to claim 29, having a high modulus of elasticity of >70 GPa.

49. The flat float glass according to claim 29, having a good chemical resistance to water, acids and alkalis, with a Class 1 hydrolytic resistance, at least Class 3 acid resistance and at least Class 2 alkali resistance.

50. The flat float glass according to claim 29, comprising, in % by weight based on the total composition:

| | |
|---|---|
| Li₂O | 3.0-6.0 |
| Σ Na₂O + K₂O | <2 |
| Σ MgO + CaO + SrO + BaO | <4 |
| ZnO | 0-1.5 |
| B₂O₃ | 0-<4 |
| Al₂O₃ | 18-28 |
| SiO₂ | 60-72 |
| Σ TiO₂ + ZrO₂ | <2 (in order to avoid the crystallization |
| | of undesirable beta-quartz and/or keatite |
| | solid solutions) |
| SnO₂ | 0.1-1.5 |
| | (as refining agent) |
| F | 0-2 |
| P₂O₅ | 0-3. |

51. The flat float glass according to claim 29, having a coefficient of thermal expansion α_{20/300} of between 3.8 and 4.5·10⁻⁶/K, a transformation temperature Tg of between 600 and 680° C., a working point V_{A} of between 1280-1320° C., and, in % by weight based on the total composition, comprises:

| | |
|---|---|
| Li₂O | 3.5-5.0 |
| Σ Na₂O + K₂O | <1.5 |
| Σ MgO + CaO + SrO + BaO | <3 |
| ZnO | 0-1.0 |
| B₂O₃ | 0-<3 |
| Al₂O₃ | 19-26 |
| SiO₂ | 62-70 |
| Σ TiO₂ + ZrO₂ | <1.5 (in order to avoid the |
| | crystallization of undesirable beta-quartz |
| | and/or keatite solid solutions) |
| SnO₂ | 0.1-1.0 |
| | (as refining agent) |
| F | 0-1.8 |
| P₂O₅ | 0-2. |

52. The flat float glass according to claim 29, having a fluorine content F of 0.1-1.2% by weight.

53. The flat float glass according to claim 29, wherein the glass is technically BaO-free.

54. The flat float glass according to claim 29, wherein, to achieve a low number of bubbles, in addition to the refining agent SnO₂, at least one further chemical refining agent which is compatible with the float process.

55. The flat float glass according to claim 54, wherein said at least one further chemical refining agent is cerium oxide, a sulphate compound, a chloride compound or a fluorine compound.

56. The flat float glass according to claim 29, wherein, to achieve a low number of bubbles the glass melt is refined physically, for example by means of reduced pressure or by means of high temperature >1680° C.

57. The flat float glass according to claim 29, having an Fe₂O₃ content of less than 250 ppm and a TiO₂ content of less than 1% by weight, and a light transmission, at a thickness of 4 mm, of >90%.

58. The flat float glass according to claim 29, wherein the absorption in the UV and/or infrared is set adding at least one composition selected from the group consisting of iron oxide, selenium oxide, nickel oxide, cobalt oxide, cerium oxide, copper oxide, and titanium oxide, in a total quantity of <1% by weight.

59. The flat float glass according to claim 29, having a color cast which is present as a result of contamination or UV- and/or IR-absorbing substances is reduced by the addition of at least one decolorizing agent elected from the group consisting of manganese oxide or selenium oxide, or a color-change agent selected from the group consisting of cobalt oxide, nickel oxide, chromium oxide or rare earth oxides, and the color locus is shifted towards the achromatic point.

60. The flat float glass according to claim 29, wherein the glass is colored using a coloring agent.

61. The flat float glass according to claim 60, wherein said coloring agent is selected from the group consisting of vanadium, chromium, cobalt, iron, chromium, copper, and a nickel compound, and the light transmission at a thickness of 4 mm is <80%.
